(19) United States
(12) Patent Application Publication
(10) Pub. No.: US 2016/0004833 A1
(43) Pub. Date: Jan. 7, 2016

(54) Compliance system and a method for promoting compliance

(71) Applicant: Sanjay Jadhav Patil, Irvine, CA (US)

(72) Inventor: Sanjay Jadhav Patil, Irvine, CA (US)

(21) Appl. No.: 14/120,861

(22) Filed: Jul. 3, 2014

(51) Int. Cl. G06F 19/00

(52) U.S. Cl. CPC G06F 19/3418; G06F 19/322

(57) ABSTRACT

A system 10 and a methodology 10 for promoting compliance by a patient with a medical care plan which resides within an electronic medical records system 12.

### GENERAL BACKGROUND

1. Field of the Invention

The present invention generally relates to a compliance system and to a method for promoting compliance and more particularly, to a system and to a method for increasing the likelihood that a patient will adhere to and comply with a medical care plan of treatment.

2. Background of the Invention

The use of electronic medical record type computer systems has been governmentally mandated as part of the health care system reformation occurring in the United States. A great many providers of such systems have emerged, each with different and unique data processing methodologies, but providing the ability to electronically store and allow selective access to the medical records of various individuals (i.e., patients). Some non-limiting examples of electronic medical record systems include the system commonly referred to as “Epic®” and discussed at www.epicmedicalrecords.com and the Centricity® system provide by The General Electric Corporation. The use of these systems has arguably increased overall patient safety and increased medical service delivery efficiency.

The aforementioned reformation has further necessitated the need to monitor chronically ill patients (and recently discharged patients) at remote locations from a hospital (e.g., such as in the respective homes of these patients) and to increase the probability that patients comply with their plan of care (e.g., medicines are taken, prescriptions are filled and follow up appointments made and attended). That is, under this reformation, hospitals are monetarily penalized for the readmission of previously discharged patients and for frequently having chronically ill patients enter the hospital facilities for testing or other procedures.

Moreover, many patients who do not comply with their medical plan of care (e.g., they do not take their prescribed medication), not only cause hospitals to be monetarily penalized by having to be readmitted, the also place their health at risk and increase the overall cost of care (e.g., patients who do not follow their plan of care are far more likely to later need more intensive care). Since there are no effective systems in place to monitor such non-compliance, overall health care costs are detrimentally affected (e.g., by undesirable readmissions and costly follow on care).

There is therefore a need to increase the likelihood of patient compliance and it is an object of this invention to do so by the use of existing electronic medical records systems.

### SUMMARY OF THE INVENTION

It is a first non-limiting object of the present invention to provide a system and a method for promoting patient compliance with a medical care plan.

It is a second non-limiting object of the present invention to provide a system and a method for increasing the likelihood of having a patient comply with a medical care plan by selectively providing outreach to the patient.

According to a first non-limiting aspect of the present invention, a compliance system is provided for use with an electronic medical records assembly having information associated with a patient. The compliance system includes a first portion which is communicatively coupled to the electronic medical records assembly; and an outreach portion which is coupled to the first portion and wherein the first portion which uses the information to determine whether an outreach is necessary for the patient and which communicates said needed outreach to the outreach portion, and wherein the outreach portion, upon receipt of the communication needed outreach, provides outreach to the patient.

According to a second non-limiting aspect of the present invention, a compliance system for the use with an electronic medical records assembly having an informational record associated with a patient is provided the informational record includes discharge instructions and the compliance system comprises a first portion which is coupled to the electronic medical records assembly, captures the discharge instructions included within the informational record associated with the patients; and an automated outreach portion which is coupled to the first portion, until reads the discharge instructions, and which provides outreach to the patients by the outreach portion and providing a plurality of optional responses for the patient to select, wherein the plurality of option comprises scheduling an appointment, confirming an appointment has been scheduled, receiving a reminder telephone call, or declining any further follow up, and wherein the outreach portion recognizes the selection made by the patient and communicates the selection to the first portion and causing the first portion to communicate the selection to the information record of the patient within the electronic medical records assembly.

According to a third non-limiting aspect of the present invention, a method for promoting medical is provided and comprises comprising the steps of accessing information about a patient resident or within an electronic medical records system; automatically calling the patient to schedule an appointment only by use of the accessed information; prompting the patient to schedule an appointment; scheduling an appointment after being directed to do so by the patient in response to said prompt; and noting said scheduled appointment within the electronic medical records system.

These and other features, aspects, and advantages of the present invention will become apparent from a reading of the detailed description of the preferred embodiment of the invention, including the subjoined claims, and by reference to the following drawings.

### BRIEF DESCRIPTION OF THE DRAWINGS

FIG. 1 is a block diagram of a system which is made in accordance with the teachings of the preferred embodiment of the invention and which is further shown in operative combination with an electronic medical records system.

FIG. 2 is a flow chart comprising a plurality of steps which cooperatively form a methodology of the preferred embodiment of the invention.

### DETAILED DESCRIPTION OF THE PREFERRED EMBODIMENT OF THE INVENTION

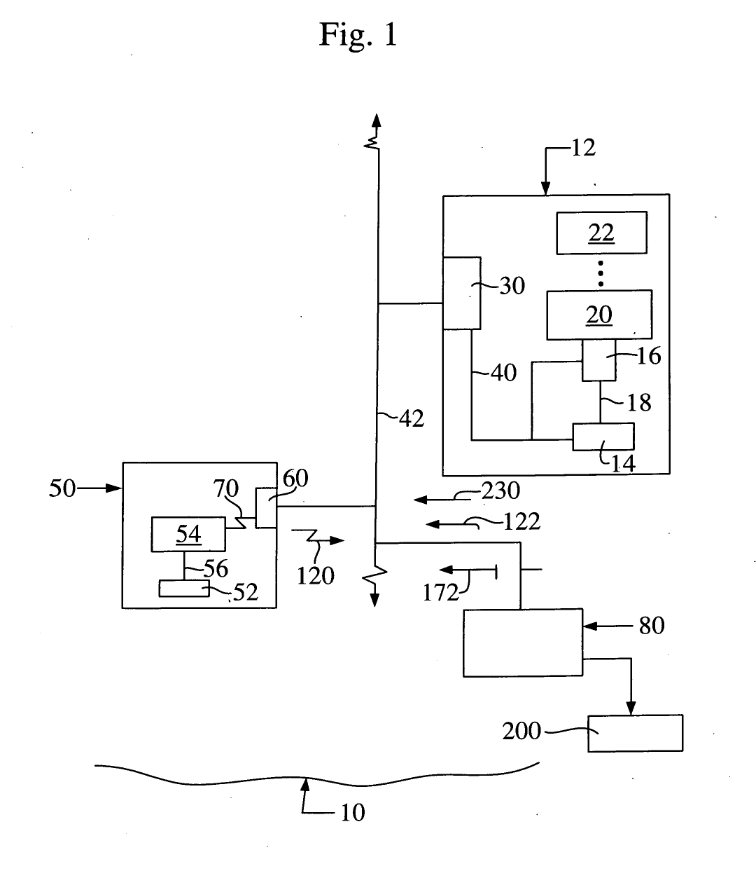

Referring now to FIG. 1, there is shown a compliance system 10 which is made in accordance with the teachings of the preferred embodiment of the invention.

Particularly, system 10 is adapted to be operatively and selectively and communicatively coupled to an electronic medical records assembly 12, such as the Epic® system which has been previously discussed. Nothing in this application is meant to limit the applicability of system 10 to any particular type of electronic medical records system and system 10 has been particularly configured to operate with a broad range of diverse electronic medical record assemblies.

An electronic medical records assembly, such as assembly 12, typically includes at least one processor assembly 14 acting under stored program control and a memory assembly 16, coupled to the at least one processor assembly 14 by bus 18. In this manner, the at least one processor assembly 14 may read information from and write information to the memory assembly 16, and the memory assembly 16 includes a plurality of medical records, such as medical records 20, 22, which are respectively associated with unique patients. The memory assembly 16 may also contain the operational code of system 12. Each record, such as records 20, 22, include patient identification data (such as the patient's name, address, telephone number, email address, social security number), medical diagnosis, history of treatment, drugs and/or other therapies which have been prescribed, and future appointments. Other information may, of course, be resident within each of these records, such as records 20, 22. Each record typically provides a history of care given to the respective patients.

The assembly 12 further and typically includes an input/output portion 30 which is coupled to the at least one processor assembly 14 by the bus 40 and which is further coupled to a communications network 42, which may comprise the Internet or a private and closed network. In this way, information may be transmitted from and received by/stored within the assembly 12. The system 12 is adapted to be coupled to a source of electrical energy.

System 10 includes a first intermediate portion 50 which comprises a processor assembly 52 which is operable under stored program control and a memory assembly 54 which is coupled to the processor assembly 52 by a bus 56. In this manner, the processor assembly 52 may access information from and write information to the memory assembly 54 and the stored control program may reside within the memory assembly 54. The system 10 further includes an input/output portion 60 which is coupled to the network 42 and which is further operatively and communicatively coupled to the processor assembly 52 by the bus 70. In this manner, the processor assembly 52 may communicate with other entities which are similarly coupled to the network 42, such as with the at least one processor assembly 14.

The system 10 further includes an outreach portion 80 which is coupled to the network 42 and which may comprise a commercially available IVR Telephone system assembly. Such an assembly may selectively place telephone calls to individuals and provide a variety of data which will be discussed. The outreach portion 80 communicates with and is under the control of intermediate portion 50 by use of the network 42.

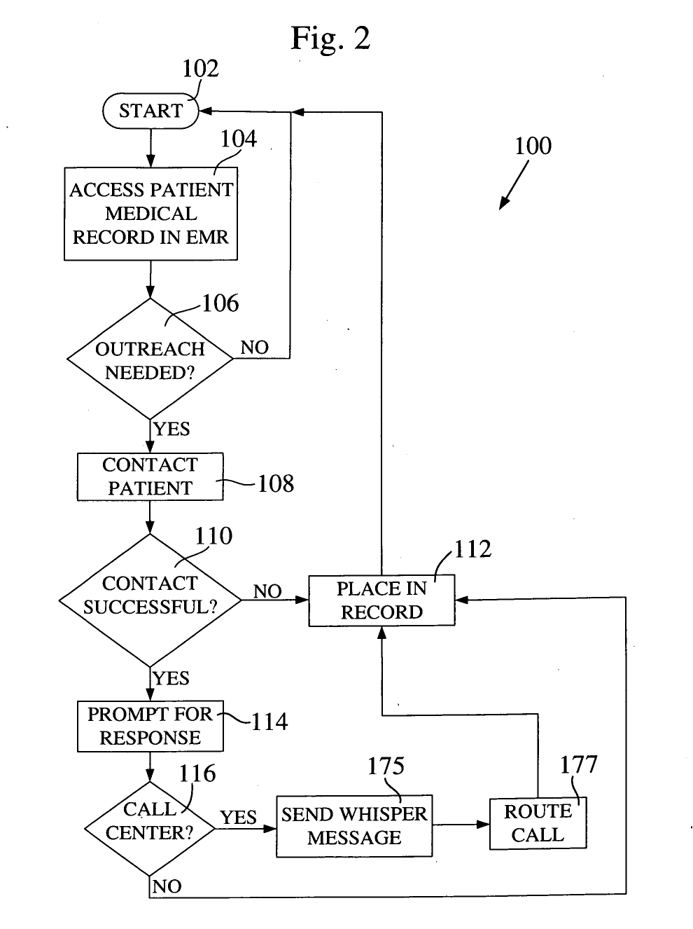

Referring now to FIG. 2, there is shown a methodology 100 which comprises the methodology of the preferred embodiment of the invention. Particularly, methodology 100 includes a first step 102 in which the methodology 100 begins. Step 102 is followed by step 104 in which the portion 50 accesses the system 12, by use of the network 42 and portions 30 and 60, an accesses a medical record of a patient. Step 104 is followed by step 106 in which the processor assembly 56 determines whether some action is required of the patient to comply with a medical care plan. Some non-limiting examples of such required patient actions include filling a prescription, scheduling a medical appointment, providing some information to a medical provider, or keeping the medical appointment on a personal schedule. If no actions are noted as being required of the patient, then step 106 is followed by step 100. Alternatively, step 106 is followed by step 108 in which the portion 50 generates a signal 120 to the outreach portion 80 to provide outreach to the identified patient. The signal 120, which is communicated upon network 42, includes the patient name, telephone number, and the action(s) required to be taken by the patient.

Upon receipt of the signal 120, the outreach portion 80, in step 108, attempts to contact the identified patient, by telephone. Step 110 follows step 108 and, in this step, the portion 80 generates a signal 122 to the portion 50, informing the portion 50 whether telephone contact was successful. If such contact was not successful, then step 110 is followed by step 112 in which the unsuccessful attempt is placed in the patient record located in the system 10. Alternatively, step 112 is followed by step 114 in which the patient is reminded of the future action(s) required and prompted for a response. A response, in this non-limiting embodiment, may include the receipt of a telephone signal generated by the depression of a telephone key by the patient acknowledging that the patient received the reminder or the depression of a second key, by the patient, which signifies that the patient wants to speak with someone about the required action.

Step 114 is followed by step 116 in which it is determined whether the patient wants to speak with someone regarding this future action. If the patient did not wish to speak with someone, then step 116 is followed by step 112 in which the acknowledgement of the patient is communicated, in a signal 172, sent to the portion 50 by use of the network 42, and then placed in the record of the patient which is located in system 12. Alternatively, step 116 is followed by step 175 in which the portion 80 sends a whisper message to a call center 200, by use of a telephone call, which provides the identification of the patient and the reason that the patient was called and then step 175 is followed by step 177 in which the call is transferred to the call center 200. Step 178 is followed by step 112 in which the call transfer is acknowledged in a signal 230 which is sent to the portion 50, by use of the network 42, and then placed in the record of the patient located in the system 10.

It is to be understood that various changes and modifications may be made to the foregoing inventions without departing from the spirit and the scope of the inventions as they are delineated in the following claims.

1. a compliance system for use with an electronic medical records assembly having information associated with a patient, said compliance system comprising a first portion is communicatively coupled to said electronic medical records assembly; and an outreach portion which is coupled to said first portion and wherein said first portion which uses said information to determine whether an outreach is necessary for said patient and which communicates said needed outreach to said outreach portion, and wherein said outreach portion, upon receipt of said communicated outreach, provides such outreach to said patient.

2. The compliance system of claim 1 wherein said outreach comprises a telephone call.

3. The compliance system of claim 1 wherein said outreach comprises a text message.

4. The compliance system of claim 1 wherein said outreach portion provides an outreach verification signal to said first portion upon said completion of said outreach.

5. The compliance system of claim 4 wherein said first portion, upon receipt of said verification signal, provides the verification information to said electronic medical records assembly and placed within a record of said patient.

6. A compliance system for the use with an electronic medical records assembly having an informational record associated with a patient, wherein said informational record includes discharge instructions and wherein said compliance system comprises a first portion which is coupled to said electronic medical records assembly, which captures said discharge instructions included within said informational record associated with said patients; and an automated outreach portion which is coupled to said first portion, until reads said discharge instructions, and which provides outreach to said patients, wherein said outreach comprises a telephone call which is made to said patient by said outreach portion and providing a plurality of optional responses for said patient to select, wherein said plurality of option comprises scheduling an appointment, confirming an appointment has been scheduled, receiving a reminder telephone call, or declining any further follow up, and wherein said outreach portion recognizes the selection made by said patient and communicates said selection to said first portion and causing said first portion to communicate said selection to said information record of said patient within said electronic medical records assembly.

7. The compliance assembly of claim 6 further comprising generating information, by said outreach portion, to a call center depending upon said selection made by said patient.

8. The compliance assembly of claim 7 further comprising providing a whisper message to said call center.

9. The compliance assembly of claim 8 further comprising noting an occurrence in which a patient has been failed to be contacted, and placing said information within said electronic medical records assembly.

10. A method for promoting medical compliance comprising the steps of accessing information about a patient resident or within an electronic medical records system; automatically calling said patient to schedule an appointment only by use of said accessed information; prompting said patient to schedule an appointment; scheduling an appointment after being directed to do so by said patient in response to said prompt; and noting said scheduled appointment within said electronic medical records system.
